(19) United States
(12) Patent Application Publication
(10) Pub. No.: US 2025/0364165 A1
(43) Pub. Date: Nov. 27, 2025

(54) SOFT MAGNETIC STEEL SHEET AND METHOD FOR MANUFACTURING THE SAME

(71) Applicant: HONDA MOTOR CO., LTD., Tokyo (JP)

(72) Inventors: Kai TSUNEKAWA, Saitama (JP); Yoshiyuki NAKAZAWA, Saitama (JP); Hitoshi ITAMI, Saitama (JP)

(21) Appl. No.: 19/204,918

(22) Filed: May 12, 2025

(30) Foreign Application Priority Data
May 22, 2024 (JP) 2024-083138

(51) Int. Cl. H01F 1/147; C21D 1/74; C21D 6/00; C21D 9/46; C22C 38/00; C22C 38/02; C22C 38/16; C22C 38/34; C22C 38/42; H01F 41/00

(52) U.S. Cl. CPC H01F 1/14775; C21D 1/74; C21D 6/004; C21D 6/008; C21D 9/46; C22C 38/008; C22C 38/02; C22C 38/16; C22C 38/34; C22C 38/42; H01F 41/00; C22C 2202/02

(57) ABSTRACT

A soft magnetic steel sheet manufactured from a raw material containing iron scrap includes Fe as a base material, 1.0 to 7.0 wt % of Si, and components derived from the iron scrap. The components derived from the iron scrap include 0.10 to 1.0 wt % of Cu, 0.01 to 0.5 wt % of Cr, 0.01 to 0.5 wt % of Ni, and 0.01 to 0.3 wt % of Sn, and a sum of Cu, Cr, Ni, and Sn is in a range of 0.1 to 1.2 wt %, and an average crystal grain size is in the range of 150 to 550 μm.

### TECHNICAL FIELD

The present invention relates to a soft magnetic steel sheet and a method for manufacturing the same.

### BACKGROUND ART

In recent years, active efforts have been made to significantly reduce waste through preventing creation of, reducing, reusing, and recycling of waste materials. To further promote these efforts, research and development on the recycling of iron scrap is being carried out.

Conventionally, a technology for manufacturing electromagnetic steel sheets, which are used as iron cores or the like, by using recycled iron scrap is known in the art. For example, JP6989000B2 discloses a non-oriented electromagnetic steel sheet having a composition of C: 0.0050 mass % or less, Si: 1.5 to 5. 0 mass %, Mn: 0.2 to 3.0 mass %, sol. Al: 0.0030 mass % or less, P: 0.2 mass % or less, S: 0.0050 mass % or less, N: 0.0040 mass % or less, T. Ca: 0.0010 to 0.0080 mass %, T. O: 0.0100 mass % or less, REM: 0.0001 to 0.0050 mass %, and the rest thereof consisting of Fe and inevitable impurities.

According to this prior art disclosed in JP6989000B2, the electromagnetic steel sheet is manufactured by hot rolling a slab to obtain a hot-rolled steel sheet and further cold rolling the hot-rolled steel sheet to obtain a cold-rolled steel sheet. When adopting a manufacturing method that performs such hot rolling, the inevitable impurities contained in the electromagnetic steel sheets have to be kept below the predetermined allowable levels (for example, Cu is required to be 0.01 mass % or less) to ensure the necessary magnetic properties and avoid any issues (such as cracking of the steel sheet during the rolling process) in the manufacturing process.

On the other hand, iron scrap contains relatively high levels of components that become impurities in electromagnetic steel sheets, as opposed to iron ore from which the regular steel is produced. Since some of these impurities (such as Cu and the like) cannot be adequately removed even by refining process using an electric furnace or the like, it may be difficult to achieve the allowable levels of inevitable impurities in the electromagnetic steel sheets as described in JP6989000B2. Among the inevitable impurities contained in iron scrap, Cu and Sn are known to adversely affect hot workability by causing precipitation embrittlement in high temperatures and oxidizing atmospheres, and this problem is further exacerbated when Cu and Sn are both present. Moreover, since Ni and Cr harden the steel material, they have an adverse effect on the cold workability. Furthermore, inclusions generated in the crystal structure by these impurity elements adversely affect the cold workability and significantly deteriorate the magnetic properties due to pinning of magnetic domain wall movement and generation of magnetic domains.

Furthermore, since electromagnetic steel sheets that contain such impurities have a different crystal grain size compared to electromagnetic steel sheets that do not contain impurities (for example, the crystal grain size is smaller), there are concerns that this may have an adverse effect on the properties (such as the magnetic properties) of the electromagnetic steel sheets. As a result of earnest studies, the inventors of the present application found that deterioration of properties of electromagnetic steel sheets can be suppressed by controlling the crystal grain size by performing an appropriate heat treatment on electromagnetic steel sheets containing impurities.

### SUMMARY OF THE INVENTION

In view of the above background, an object of the present invention is to provide a soft magnetic steel sheet and a manufacturing method thereof that can suppress deterioration of magnetic properties and the like, even when impurities derived from iron scrap are contained in raw materials. Furthermore, the present invention contributes to a significant reduction in the creation of iron scrap as waste.

To achieve such an object, one aspect of the present invention provides a soft magnetic steel sheet manufactured from a raw material containing iron scrap, the soft magnetic steel sheet including: Fe as a base material; 1.0 to 7.0 wt % of Si; and components derived from the iron scrap, wherein the components derived from the iron scrap include 0.10 to 1.0 wt % of Cu, 0.01 to 0.5 wt % of Cr, 0.01 to 0.5 wt % of Ni, and 0.01 to 0.3wt % of Sn, and a sum of Cu, Cr, Ni, and Sn is in a range of 0.1 to 1.2 wt %, and an average crystal grain size is in the range of 150 to 550 μm.

According to this aspect, even when the raw materials contain impurities derived from iron scrap, the deterioration of magnetic properties and the like can be suppressed.

In the above aspect, preferably, a grain size of Cu—Sn precipitate is 60 nm or less.

According to this aspect, even when the raw materials contain impurities derived from iron scrap, it is possible to more reliably suppress the deterioration of magnetic properties and the like.

In the above aspect, the soft magnetic steel sheet has a thickness of 0.03 to 0.15 mm and iron loss W10/400 of 8 W/kg or less.

According to this aspect, a high quality soft magnetic steel sheet can be manufactured.

To achieve such an object, one aspect of the present invention is a method for manufacturing the soft magnetic steel sheet comprising steps of: forming a belt-shaped thin sheet from the raw material by a solidification method to rapidly cool a liquid on a single roll; and heat treating the belt-shaped thin sheet in an inert atmosphere at 1,100 to 1,300°° C. for 10 minutes to 48 hours.

According to this aspect, even when the raw materials contain impurities derived from iron scrap, the belt-shaped thin sheet is formed by the solidification method to rapidly cool a liquid on a single roll, so that cracking of the steel sheet during the hot rolling process of a slab can be avoided. Further, even when the raw materials contain impurities derived from iron scrap, the deterioration of magnetic properties and the like can be suppressed.

In the above aspect, preferably, a temperature of the heat treating step is 1,150 to 1,250° C.

According to this aspect, even when the raw materials contain impurities derived from iron scrap, it is possible to more reliably suppress the deterioration of magnetic properties and the like.

In the above aspect, preferably, a time period of the heat treating step is 2 to 24 hours.

According to this aspect, even when the raw materials contain impurities derived from iron scrap, it is possible to more reliably suppress the deterioration of magnetic properties and the like.

Thus, according to the above aspects, even when the raw materials contain impurities derived from iron scrap, the deterioration of magnetic properties and the like of the soft magnetic steel sheet can be suppressed.

### BRIEF DESCRIPTION OF THE DRAWING(S)

FIG. 1 is an explanatory diagram showing a manufacturing device of a soft magnetic steel sheet to which a solidification method to rapidly cool a liquid on a single roll (a single roll method) is applied;

FIG. 2 is a graph showing a relationship between an amount of impurities and iron loss W10/400;

FIG. 3 is a graph showing the relationship between a crystal grain size and iron loss W10/400;

FIG. 4 is a graph showing the relationship between the amount of impurities and the crystal grain size;

FIG. 5 is a graph showing the relationship between a heat treatment temperature and the crystal grain size;

FIGS. 6A to 6D show transmission electron microscope (TEM) images of the soft magnetic steel sheet;

FIG. 7 is a graph showing the relationship between the amount of impurities and a grain size of the Cu—Sn precipitate;

FIG. 8 is a graph showing the relationship between the amount of impurities and the grain size of the Cu—Sn precipitate;

FIG. 9 is a graph showing the relationship between the grain size of the Cu—Sn precipitate and iron loss W10/400; and

FIG. 10 is a graph showing the relationship between the grain size of the Cu—Sn precipitate and iron loss W10/400.

### DETAILED DESCRIPTION OF THE INVENTION

In the following, an embodiment according to the present invention will be described with reference to the drawings.

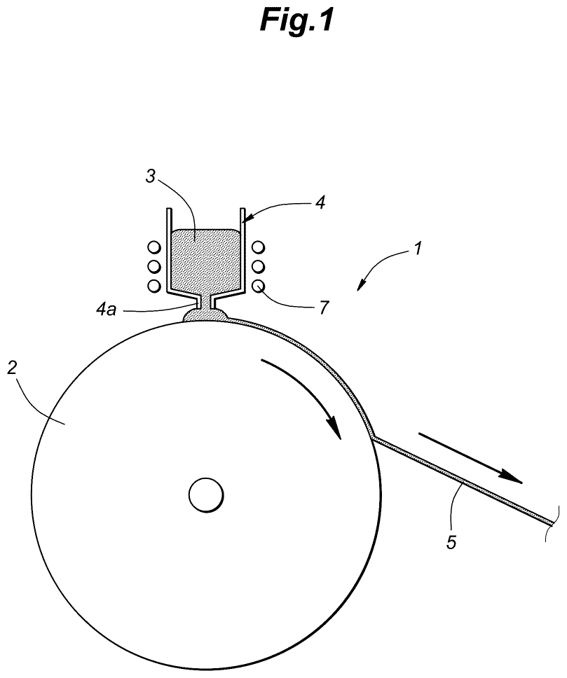

As shown in FIG. 1, a manufacturing device 1 for a soft magnetic steel sheet is an apparatus that applies a solidification method to rapidly cool a liquid on a single roll (a single roll method). The manufacturing device 1 includes a rotatable cooling roll 2 and a nozzle 4 that discharges molten metal 3 serving as a raw material for the soft magnetic steel sheet.

In the manufacturing device 1, the molten metal 3 is discharged from an injection hole 4a of the nozzle 4 toward the cooling roll 2 that rotates at the predetermined speed (for example, 500 to 2000 rpm). The discharged molten metal 3 is rapidly cooled on a surface of the cooling roll 2, thereby forming a belt-shaped thin sheet 5 along the surface of the cooling roll 2 (an example of the belt-shaped thin sheet forming step). The belt-shaped thin sheet 5 is peeled off from the surface of the cooling roll 2, and continuously wound up by a winding device (not shown) so that a coil of the belt-shaped thin sheet 5 is formed.

The cooling roll 2 has a diameter of 200 mm and an outer surface made of Cu—Cr alloy or carbon steel. Further, a heater 7 is attached around the nozzle 4 so that the temperature of the molten metal 3 inside the nozzle 4 is maintained appropriately. Further, the molten metal 3 is discharged from the injection hole 4a by the pressure of a gas (for example, nitrogen gas) supplied into the nozzle 4.

The coil of the belt-shaped thin sheet 5 formed by the manufacturing device 1 is heat treated (annealed) in an inert atmosphere in a heating furnace (not shown) (an example of the heat treating step). Thereby, the soft magnetic steel sheet having the predetermined magnetic properties is obtained. The inert atmosphere can be achieved by filling the furnace with an inert gas such as argon gas or helium gas. However, the furnace may also be filled with nitrogen gas, hydrogen gas, or the like. Furthermore, the internal stress of the belt-shaped thin sheet 5 is removed, and an improvement in the structure is achieved by the heat treatment in the heating furnace.

The temperature of the heat treatment may be in the range of 1,100 to 1,300° C., more preferably in the range of 1,150 to 1,250°° C. The time period for the heat treatment may be in the range of 10 minutes to 48 hours, more preferably in the range of 2 to 24 hours. Accordingly, even if the raw material contains impurities derived from iron scrap described later, the crystal grain size (average value) of the belt-shaped thin sheet 5 (the soft magnetic steel sheet) can be kept in an appropriate range (here, 150 to 550 μm). Further, the grain size of the Cu—Sn precipitates resulting from the impurities derived from iron scrap in the belt-shaped thin sheet 5 can be kept in an appropriate range (here, 60 nm or less). Accordingly, the deterioration of the properties (here, the iron loss) of the belt-shaped thin sheet 5 can be suppressed compared to a case in which the impurities derived from iron scrap are not contained.

Further, in the manufacture of the soft magnetic steel sheet, after forming the belt-shaped thin sheet 5, warm rolling and/or cold rolling may be performed on the belt-shaped thin sheet 5 before heat treatment. The warm rolling may be performed on the belt-shaped thin sheet 5 at a temperature in the range of 600 to 900° C. by using, for example, a per se known warm rolling mill. Further, the cold rolling is performed on the belt-shaped thin sheet 5 at room temperature by using a per se known cold rolling mill. By performing the warm rolling or the cold rolling, the surface of the belt-shaped thin sheet 5 can be smoothed, and the thickness, width, and properties of the finally obtained belt-shaped thin sheet 5 (i.e., the soft magnetic steel sheet) can be appropriately adjusted.

The raw materials used for manufacturing the soft magnetic steel sheet mainly include iron scrap which is commercially available in the recycled material market. For example, iron scrap discharged from manufacturing facilities for cars or the like, or iron scrap recovered from scrapped cars etc. may be used as the raw material.

The iron scrap from such sources often contains, in addition to Fe (iron) which is the base material of the soft magnetic steel sheet, impurities (i.e., unnecessary components) for the soft magnetic steel sheet such as Cu (copper), Cr (chromium), Ni (nickel), Sn (tin), and the like. In other words, Cu, Cr, Ni, and Sn in the soft magnetic steel sheet are components derived from the iron scrap.

From the viewpoint of manufacturing the soft magnetic steel sheet in a stable manner and ensuring good magnetic properties, it is preferable that the contents of the impurities (i.e., Cu, Cr, Ni, and Sn) are kept within the predetermined ranges.

The content of Cu in the soft magnetic steel sheet is preferably 0.10 to 1.0 wt % (weight percent). The content of Cr in the soft magnetic steel sheet is preferably 0.01 to 0.5 wt %. The content of Ni in the soft magnetic steel sheet is preferably 0.01 to 0.5 wt %. The content of Sn in the soft magnetic steel sheet is preferably 0.01 to 0.3 wt %. Further, in the soft magnetic steel sheet, the sum of Cu, Cr, Ni, and Sn contents is preferably in a range of 0.1 to 1.2 wt %, more preferably 1.0 wt % or less. Although the lower limit of the content of each impurity is shown here, none of these impurities are essential for the soft magnetic steel sheet. Accordingly, the contents of one or more of the impurities may be zero.

If the content of any of these impurities should exceed the upper limit of the desired range, it can be adjusted to be below the allowable range by, for example, selecting the type of iron scrap used as raw material.

In order to reduce iron loss, it is preferable to add Si (silicon) to the raw material as a component that is lacking in the iron scrap. The content of Si in the manufactured soft magnetic steel sheet is preferably 1.0 to 7.0 wt %.

The thickness of the finally obtained soft magnetic steel sheet is preferably 0.03 to 0.15 mm. Further, the soft magnetic steel sheet is desired to have favorable properties, such as an iron loss W10/400 of 8 W/kg or less. “Iron loss W10/400” means the iron loss at a frequency of 400 Hz and a magnetic flux density of 1.0 T.

### EXAMPLES

As Examples 1 to 40, samples of soft magnetic steel sheet were manufactured by using raw materials in which the base material consists of Fe (i.e., the main component excluding other components such as impurities) and the impurity contents of Cu, Cr, Ni, and Sn are varied from one Example to another, and the magnetic properties of each sample were evaluated. However, Examples 1 to 40 include Examples having the same impurity contents and the heat treatment conditions.

In manufacturing the soft magnetic steel sheets for each Example 1 to 40, first, the raw materials containing impurities in the corresponding ratios were prepared. More specifically, pure iron and ferrosilicon were mixed and melted, and impurities (here, Cu, Cr, Ni, and Sn) were mixed therein by corresponding amounts to achieve each predetermined chemical composition in a case where the total contents of Fe, Si, and impurities were 100 wt % (see Table 1). The Si content was adjusted to 1.0 to 7. 0 wt %.

Thereafter, as described above, the belt-shaped thin sheets 5 were formed by using the manufacturing device 1 (see FIG. 1) based on the single roll method. More specifically, by discharging the molten metal 3 from the injection hole 4a of the nozzle 4 onto the outer circumferential surface of the cooling roll 2 and rapidly cooling and solidifying the molten metal 3, the belt-shaped thin sheets 5 having a width of 20 mm within the predetermined thickness range (0.03 to 0.15 mm) were formed. At this time, the temperature of the molten metal 3 was adjusted to 1400 to 1700° C., the circumferential speed of the cooling roll 2 was adjusted to 5 to 20 m/s, the discharge pressure of the molten metal 3 was adjusted to 10 kPa to 40 kPa, and the gap between the tip of the nozzle 4 and the cooling roll 2 was adjusted to 0.2 mm to 0.4 mm.

Furthermore, the obtained belt-shaped thin sheet 5 was heat treated in an inert atmosphere (here, Ar gas) of the heating furnace under a plurality of conditions (see Table 1) as described above.

In addition, as in Comparative Examples 1 to 25, soft magnetic steel sheets were manufactured in the same manner as Examples 1 to 40 by using raw materials that did not substantially contain Cu, Cr, Ni, and Sn as impurities, and the magnetic properties and the like were evaluated. However, Comparative Examples 1 to 25 include Examples having the same heat treatment conditions.

Further, the soft magnetic steel sheets were manufactured by using a conventional hot rolling process (hereinafter referred to as “Conventional Art 1”), and the magnetic properties thereof were evaluated. In Conventional Art 1, an ingot whose chemical composition was adjusted in a vacuum melting furnace was hot rolled to a thickness of 2 mm at a temperature of 1,100° C., and then cold rolled to form a steel sheet having a thickness of 0.1 mm. The obtained steel sheet was heat treated in the same manner as in Examples 1 to 40.

Regarding Examples 1 to 40, Table 1 shows the chemical composition and the heat treatment conditions (temperature, time), and Table 2 shows the evaluation items (grain size of Cu—Sn precipitate, crystal grain size, and magnetic properties). The Cu—Sn precipitate corresponds to the portion where Cu and Sn are concentrated in the crystal grain boundaries and the like (Cu—Sn concentrated alloy).

The crystal grain size of the soft magnetic steel sheet was calculated as follows. A portion (1 cm square) of the soft magnetic steel sheet sample was cut out and embedded in resin. Thereafter, the observation surface was mirror-finished by mechanical polishing, and then etched with a nital solution (nitric acid concentration 5%). The observation samples thus prepared were observed under a stereomicroscope at magnifications of 5 to 50 times. For the observed microstructure photographs, the average crystal grain size was calculated by a cutting method using a circular test line. The average crystal grain size was calculated according to JIS G0551, and analysis was conducted using an image with a magnification such that the circular test line captured 50 or more crystal grains.

Further, the grain size of the Cu—Sn precipitate of the soft magnetic steel sheet was calculated as follows. The surface of the soft magnetic steel sheet sample was polished, and then punched out to a size of φ3 mm, followed by electrolytic polishing to prepare a sample for observation. The observation samples were observed at magnifications of 10,000 to 500,000 by using a transmission electron microscope (TEM) (Talos F200X, Thermo Scientific). The Cu—Sn precipitate was identified by elemental analysis using energy dispersive X-ray spectroscopy (EDX) and diffraction patterns from TEM. The maximum and minimum values of the grain size of the Cu—Sn precipitate were calculated as a circle equivalent diameter of the area of the Cu—Sn precipitate in the observation region.

TABLE 1

| | chemical composition [wt %] | | | | | | | | heat treatment | | |
|---|---|---|---|---|---|---|---|---|---|---|---|
| | | | | | | | | impurity | temp | time | |
| No. | Si | Cu | Sn | Ni | Cr | Mn | Al | amount | [° C.] | [h] | atmosphere |
| Example1 | 3 | 0.5 | 0.2 | 0 | 0 | 0 | 0 | 0.7 | 1150 | 24 | Ar |
| Example2 | 3 | 0.5 | 0.2 | 0 | 0 | 0 | 0 | 0.7 | 1150 | 24 | Ar |
| Example3 | 3 | 0.1 | 0.2 | 0 | 0 | 0 | 0 | 0.3 | 1150 | 24 | Ar |
| Example4 | 3 | 0.2 | 0.2 | 0 | 0 | 0 | 0 | 1.2 | 1150 | 24 | Ar |
| Example5 | 3 | 0.2 | 0.2 | 0 | 0 | 0 | 0 | 0.4 | 1150 | 24 | Ar |
| Example6 | 3 | 0.2 | 0.1 | 0.05 | 0.09 | 0 | 0 | 0.44 | 1150 | 24 | Ar |
| Example7 | 3 | 0.2 | 0.1 | 0.05 | 0.09 | 0 | 0 | 0.44 | 1150 | 24 | Ar |
| Example8 | 3 | 0.2 | 0.1 | 0.05 | 0.09 | 0 | 0 | 0.44 | 1150 | 24 | Ar |
| Example9 | 3 | 0.2 | 0.1 | 0.05 | 0.09 | 0 | 0 | 0.44 | 1150 | 24 | Ar |
| Example10 | 3 | 0.2 | 0.1 | 0.05 | 0.09 | 0 | 0 | 0.44 | 1150 | 24 | Ar |
| Example11 | 3 | 0.2 | 0.1 | 0.05 | 0.09 | 0 | 0 | 0.44 | 1150 | 24 | Ar |
| Example12 | 3 | 0.2 | 0.1 | 0.05 | 0.09 | 0 | 0 | 0.44 | 1150 | 24 | Ar |
| Example13 | 3 | 1.6 | 0.3 | 0 | 0 | 0 | 0 | 1.9 | 1150 | 24 | Ar |
| Example14 | 3 | 2.1 | 0.5 | 0 | 0 | 0 | 0 | 2.6 | 1150 | 24 | Ar |
| Example15 | 3 | 3.6 | 0.7 | 0 | 0 | 0 | 0 | 4.3 | 1150 | 24 | Ar |
| Example16 | 3 | 1.2 | 0.25 | 0 | 0 | 0 | 0 | 1.45 | 1150 | 24 | Ar |
| Example17 | 3 | 1.2 | 0.25 | 0 | 0 | 0 | 0 | 1.45 | 1150 | 24 | Ar |
| Example18 | 3 | 0 | 0 | 0.5 | 0.2 | 0 | 0 | 0.7 | 1150 | 24 | Ar |
| Example19 | 3 | 0 | 0 | 1 | 0.2 | 0 | 0 | 1.2 | 1150 | 24 | Ar |
| Example20 | 3 | 0 | 0 | 1.2 | 0.25 | 0 | 0 | 1.45 | 1150 | 24 | Ar |
| Example21 | 3 | 0 | 0 | 1.6 | 0.3 | 0 | 0 | 1.9 | 1150 | 24 | Ar |
| Example22 | 3 | 0 | 0 | 2.1 | 0.5 | 0 | 0 | 2.6 | 1150 | 24 | Ar |
| Example23 | 3 | 0.4 | 0.02 | 0.1 | 0.2 | 0 | 0 | 0.72 | 1250 | 3 | Ar |
| Example24 | 3 | 0.4 | 0.02 | 0.1 | 0.2 | 0 | 0 | 0.72 | 1150 | 3 | Ar |
| Example25 | 3 | 0.4 | 0.02 | 0.1 | 0.2 | 0 | 0 | 0.72 | 850 | 3 | Ar |
| Example26 | 3 | 0.5 | 0.2 | 0 | 0 | 0 | 0 | 0.7 | 1150 | 24 | Ar |
| Example27 | 3 | 0.1 | 0.2 | 0 | 0 | 0 | 0 | 0.3 | 1150 | 24 | Ar |
| Example28 | 3 | 0.2 | 0.2 | 0 | 0 | 0 | 0 | 0.4 | 1150 | 24 | Ar |
| Example29 | 3 | 0.2 | 0.1 | 0.05 | 0.09 | 0 | 0 | 0.44 | 1150 | 24 | Ar |
| Example30 | 3 | 0.4 | 0.02 | 0.1 | 0.2 | 0 | 0 | 0.72 | 1300 | 2 | Ar |
| Example31 | 3 | 0.4 | 0.02 | 0.1 | 0.2 | 0 | 0 | 0.72 | 1300 | 24 | Ar |
| Example32 | 3 | 0.4 | 0.02 | 0.1 | 0.2 | 0 | 0 | 0.72 | 1150 | 3 | Ar |
| Example33 | 3 | 0.4 | 0.02 | 0.1 | 0.2 | 0 | 0 | 0.72 | 1250 | 3 | Ar |
| Example34 | 3 | 0.4 | 0.02 | 0.1 | 0.2 | 0 | 0 | 0.72 | 850 | 3 | Ar |
| Example35 | 3 | 0.4 | 0.02 | 0.1 | 0.2 | 0 | 0 | 0.72 | 1100 | 3 | Ar |
| Example36 | 3 | 0.4 | 0.02 | 0.1 | 0.2 | 0 | 0 | 0.72 | 1300 | 2 | Ar |
| Example37 | 3 | 0.4 | 0.02 | 0.1 | 0.2 | 0 | 0 | 0.72 | 1150 | 24 | Ar |
| Example38 | 3 | 0.5 | 0.2 | 0 | 0 | 0 | 0 | 0.7 | 1150 | 24 | Ar |
| Example39 | 3 | 1 | 0.2 | 0 | 0 | 0 | 0 | 1.2 | 1150 | 24 | Ar |
| Example40 | 3 | 1.2 | 0.25 | 0 | 0 | 0 | 0 | 1.45 | 1150 | 24 | Ar |

In Table 2, “W10/400” indicates the iron loss at a frequency of 400 Hz and a magnetic flux density of 1.0 T. Further, “B10”, “B50”, and “B100” indicate magnetic flux densities at magnetic field strengths of 1,000 A/m, 5,000 A/m, and 10,000 A/m, respectively.

TABLE 2

| | grain size of Cu—Sn | | crystal | magnetic properties | | | |
|---|---|---|---|---|---|---|---|
| | precipitate [nm] | | grain size | W10/400 | B10 | B50 | B100 |
| No. | minimum | maximum | [μm] | [W/kg] | [T] | [T] | [T] |
| Example1 | 14 | 22 | 230 | 7.1 | 1.4 | 1.6 | 1.8 |
| Example2 | 13 | 21 | 229 | 6.9 | 1.4 | 1.6 | 1.7 |
| Example3 | 10 | 11 | 284 | 7.1 | 1.4 | 1.6 | 1.7 |
| Example4 | 18 | 56 | 257 | 7.8 | 1.4 | 1.6 | 1.7 |
| Example5 | 12 | 14 | 207 | 6.9 | 1.4 | 1.6 | 1.7 |
| Example6 | 11 | 13 | 250 | 6.9 | 1.4 | 1.6 | 1.8 |
| Example7 | 11 | 12 | 257 | 7.0 | 1.5 | 1.7 | 1.8 |
| Example8 | 12 | 14 | 250 | 6.9 | 1.4 | 1.6 | 1.7 |
| Example9 | 11 | 13 | 267 | 6.3 | 1.5 | 1.7 | 1.8 |
| Example10 | 12 | 14 | 249 | 7.3 | 1.4 | 1.6 | 1.7 |
| Example11 | 12 | 13 | 269 | 6.6 | 1.4 | 1.6 | 1.7 |
| Example12 | 13 | 15 | 261 | 6.9 | 1.5 | 1.7 | 1.8 |
| Example13 | 18 | 112 | 289 | 21.4 | 1.4 | 1.6 | 1.8 |
| Example14 | 25 | 155 | 262 | 31.9 | 1.3 | 1.6 | 1.7 |
| Example15 | 26 | 182 | 256 | 29.3 | 1.3 | 1.6 | 1.7 |
| Example16 | 20 | 67 | 260 | 22.8 | 1.4 | 1.6 | 1.7 |
| Example17 | 21 | 71 | 252 | 22.3 | 1.4 | 1.6 | 1.8 |
| Example18 | 0 | 0 | 408 | 7.1 | 1.4 | 1.6 | 1.8 |
| Example19 | 0 | 0 | 319 | 7.8 | 1.4 | 1.6 | 1.8 |
| Example20 | 0 | 0 | 298 | 22.3 | 1.4 | 1.6 | 1.8 |
| Example21 | 0 | 0 | 289 | 23.2 | 1.4 | 1.6 | 1.7 |
| Example22 | 0 | 0 | 262 | 31.9 | 1.3 | 1.6 | 1.7 |
| Example23 | 13 | 21 | 350 | 7.2 | 1.4 | 1.6 | 1.7 |
| Example24 | 12 | 22 | 241 | 7.2 | 1.5 | 1.7 | 1.8 |
| Example25 | 13 | 20 | 47 | 18.7 | 1.5 | 1.6 | 1.7 |
| Example26 | 14 | 22 | 230 | 7.1 | 1.4 | 1.6 | 1.8 |
| Example27 | 10 | 6 | 284 | 7.1 | 1.4 | 1.6 | 1.7 |
| Example28 | 12 | 14 | 207 | 6.9 | 1.4 | 1.6 | 1.7 |
| Example29 | 11 | 13 | 250 | 6.9 | 1.4 | 1.6 | 1.8 |
| Example30 | 13 | 21 | 466 | 7.5 | 1.4 | 1.6 | 1.8 |
| Example31 | 12 | 22 | 536 | 7.5 | 1.4 | 1.6 | 1.8 |
| Example32 | 14 | 20 | 241 | 6.7 | 1.5 | 1.7 | 1.8 |
| Example33 | 12 | 21 | 350 | 7.3 | 1.4 | 1.6 | 1.7 |
| Example34 | 13 | 21 | 47 | 11.9 | 1.4 | 1.6 | 1.8 |
| Example35 | 14 | 20 | 163 | 7.2 | 1.4 | 1.6 | 1.8 |
| Example36 | 12 | 23 | 360 | 6.8 | 1.4 | 1.6 | 1.8 |
| Example37 | 13 | 21 | 249 | 6.7 | 1.4 | 1.6 | 1.8 |
| Example38 | 14 | 22 | 230 | 7.1 | 1.4 | 1.6 | 1.8 |
| Example39 | 18 | 56 | 257 | 7.8 | 1.4 | 1.6 | 1.8 |
| Example40 | 27 | 158 | 269 | 22.3 | 1.4 | 1.6 | 1.8 |

As with the above-mentioned Examples 1 to 40, regarding Comparative Examples 1 to 25 and Conventional Art 1, Table 3 shows the chemical composition and the heat treatment conditions, and Table 4 shows the evaluation items.

TABLE 3

| | chemical composition [wt %] | | | | | | | | heat treatment | | |
|---|---|---|---|---|---|---|---|---|---|---|---|
| | | | | | | | | impurity | temp | time | |
| No. | Si | Cu | Sn | Ni | Cr | Mn | Al | amount | [° C.] | [h] | atmosphere |
| Comparative | 3 | 0 | 0 | 0 | 0 | 0 | 0 | 0 | 1150 | 24 | Ar |
| Example1 | | | | | | | | | | | |
| Comparative | 3 | 0 | 0 | 0 | 0 | 0 | 0 | 0 | 1150 | 24 | Ar |
| Example2 | | | | | | | | | | | |
| Comparative | 3 | 0 | 0 | 0 | 0 | 0 | 0 | 0 | 1150 | 24 | Ar |
| Example3 | | | | | | | | | | | |
| Comparative | 3 | 0 | 0 | 0 | 0 | 0 | 0 | 0 | 1150 | 24 | Ar |
| Example4 | | | | | | | | | | | |
| Comparative | 3 | 0 | 0 | 0 | 0 | 0 | 0 | 0 | 1150 | 24 | Ar |
| Example5 | | | | | | | | | | | |
| Comparative | 3 | 0 | 0 | 0 | 0 | 0 | 0 | 0 | 1150 | 24 | Ar |
| Example6 | | | | | | | | | | | |
| Comparative | 3 | 0 | 0 | 0 | 0 | 0 | 0 | 0 | 1150 | 24 | Ar |
| Example7 | | | | | | | | | | | |
| Comparative | 3 | 0 | 0 | 0 | 0 | 0 | 0 | 0 | 1150 | 24 | Ar |
| Example8 | | | | | | | | | | | |
| Comparative | 3 | 0 | 0 | 0 | 0 | 0 | 0 | 0 | 950 | 3 | Ar |
| Example9 | | | | | | | | | | | |
| Comparative | 3 | 0 | 0 | 0 | 0 | 0 | 0 | 0 | 1050 | 3 | Ar |
| Example10 | | | | | | | | | | | |
| Comparative | 3 | 0 | 0 | 0 | 0 | 0 | 0 | 0 | 1250 | 3 | Ar |
| Example11 | | | | | | | | | | | |
| Comparative | 3 | 0 | 0 | 0 | 0 | 0 | 0 | 0 | 750 | 2 | Ar |
| Example12 | | | | | | | | | | | |
| Comparative | 3 | 0 | 0 | 0 | 0 | 0 | 0 | 0 | 750 | 2 | Ar |
| Example13 | | | | | | | | | | | |
| Comparative | 3 | 0 | 0 | 0 | 0 | 0 | 0 | 0 | 750 | 2 | Ar |
| Example14 | | | | | | | | | | | |
| Comparative | 3 | 0 | 0 | 0 | 0 | 0 | 0 | 0 | 850 | 3 | Ar |
| Example15 | | | | | | | | | | | |
| Comparative | 3 | 0 | 0 | 0 | 0 | 0 | 0 | 0 | 950 | 3 | Ar |
| Example16 | | | | | | | | | | | |
| Comparative | 3 | 0 | 0 | 0 | 0 | 0 | 0 | 0 | 1050 | 3 | Ar |
| Example17 | | | | | | | | | | | |
| Comparative | 3 | 0 | 0 | 0 | 0 | 0 | 0 | 0 | 1050 | 24 | Ar |
| Example18 | | | | | | | | | | | |
| Comparative | 3 | 0 | 0 | 0 | 0 | 0 | 0 | 0 | 750 | 2 | Ar |
| Example19 | | | | | | | | | | | |
| Comparative | 3 | 0 | 0 | 0 | 0 | 0 | 0 | 0 | 1150 | 1 | Ar |
| Example20 | | | | | | | | | | | |
| Comparative | 3 | 0 | 0 | 0 | 0 | 0 | 0 | 0 | 1150 | 24 | Ar |
| Example21 | | | | | | | | | | | |
| Comparative | 3 | 0 | 0 | 0 | 0 | 0 | 0 | 0 | 1150 | 3 | Ar |
| Example22 | | | | | | | | | | | |
| Comparative | 3 | 0 | 0 | 0 | 0 | 0 | 0 | 0 | 1250 | 3 | Ar |
| Example23 | | | | | | | | | | | |
| Comparative | 3 | 0 | 0 | 0 | 0 | 0 | 0 | 0 | 1150 | 3 | Ar |
| Example24 | | | | | | | | | | | |
| Comparative | 3 | 0 | 0 | 0 | 0 | 0 | 0 | 0 | 1250 | 2 | Ar |
| Example25 | | | | | | | | | | | |
| Conventional | 3.19 | 0.12 | 0.09 | 0.06 | 0.88 | 0.14 | 0.45 | 1.15 | 1150 | 24 | Ar |
| Art | | | | | | | | | | | |

TABLE 4

| | grain size of Cu—Sn | | crystal | magnetic properties | | | |
|---|---|---|---|---|---|---|---|
| | precipitate [nm] | | grain size | W10/400 | B10 | B50 | B100 |
| No. | minimum | maximum | [μm] | [W/kg] | [T] | [T] | [T] |
| Comparative | 0 | 0 | 282 | 6.2 | 1.5 | 1.6 | 1.7 |
| Example1 | | | | | | | |
| Comparative | 0 | 0 | 189 | 6.6 | 1.5 | 1.7 | 1.8 |
| Example2 | | | | | | | |
| Comparative | 0 | 0 | 267 | 6.3 | 1.5 | 1.7 | 1.8 |
| Example3 | | | | | | | |
| Comparative | 0 | 0 | 275 | 6.7 | 1.5 | 1.7 | 1.8 |
| Example4 | | | | | | | |
| Comparative | 0 | 0 | 289 | 6.8 | 1.5 | 1.7 | 1.8 |
| Example5 | | | | | | | |
| Comparative | 0 | 0 | 241 | 6.9 | 1.5 | 1.7 | 1.8 |
| Example6 | | | | | | | |
| Comparative | 0 | 0 | 258 | 6.9 | 1.5 | 1.7 | 1.8 |
| Example7 | | | | | | | |
| Comparative | 0 | 0 | 483 | 6.2 | 1.5 | 1.7 | 1.8 |
| Example8 | | | | | | | |
| Comparative | 0 | 0 | 84 | 11.7 | 1.5 | 1.6 | 1.7 |
| Example9 | | | | | | | |
| Comparative | 0 | 0 | 114 | 11.2 | 1.4 | 1.6 | 1.7 |
| Example10 | | | | | | | |
| Comparative | 0 | 0 | 354 | 7.3 | 1.4 | 1.6 | 1.8 |
| Example11 | | | | | | | |
| Comparative | 0 | 0 | 66 | 13.1 | 1.5 | 1.8 | 1.9 |
| Example12 | | | | | | | |
| Comparative | 0 | 0 | 81 | 11.7 | 1.4 | 1.6 | 1.8 |
| Example13 | | | | | | | |
| Comparative | 0 | 0 | 70 | 12.1 | 1.4 | 1.6 | 1.8 |
| Example14 | | | | | | | |
| Comparative | 0 | 0 | 83 | 11.7 | 1.4 | 1.5 | 1.7 |
| Example15 | | | | | | | |
| Comparative | 0 | 0 | 84 | 11.2 | 1.4 | 1.6 | 1.7 |
| Example16 | | | | | | | |
| Comparative | 0 | 0 | 114 | 8.1 | 1.5 | 1.6 | 1.7 |
| Example17 | | | | | | | |
| Comparative | 0 | 0 | 410 | 6.5 | 1.4 | 1.7 | 1.8 |
| Example18 | | | | | | | |
| Comparative | 0 | 0 | 35 | 14.4 | 1.5 | 1.7 | 1.8 |
| Example19 | | | | | | | |
| Comparative | 0 | 0 | 130 | 8.7 | 1.5 | 1.6 | 1.7 |
| Example20 | | | | | | | |
| Comparative | 0 | 0 | 189 | 6.6 | 1.5 | 1.7 | 1.8 |
| Example21 | | | | | | | |
| Comparative | 0 | 0 | 179 | 7.3 | 1.4 | 1.6 | 1.8 |
| Example22 | | | | | | | |
| Comparative | 0 | 0 | 354 | 7.2 | 1.4 | 1.6 | 1.8 |
| Example23 | | | | | | | |
| Comparative | 0 | 0 | 244 | 6.3 | 1.4 | 1.6 | 1.8 |
| Example24 | | | | | | | |
| Comparative | 0 | 0 | 344 | 6.4 | 1.5 | 1.7 | 1.8 |
| Example25 | | | | | | | |
| Conventional | 5000 | 8000 | 255 | 14.3 | 1.4 | 1.6 | 1.8 |
| Art | | | | | | | |

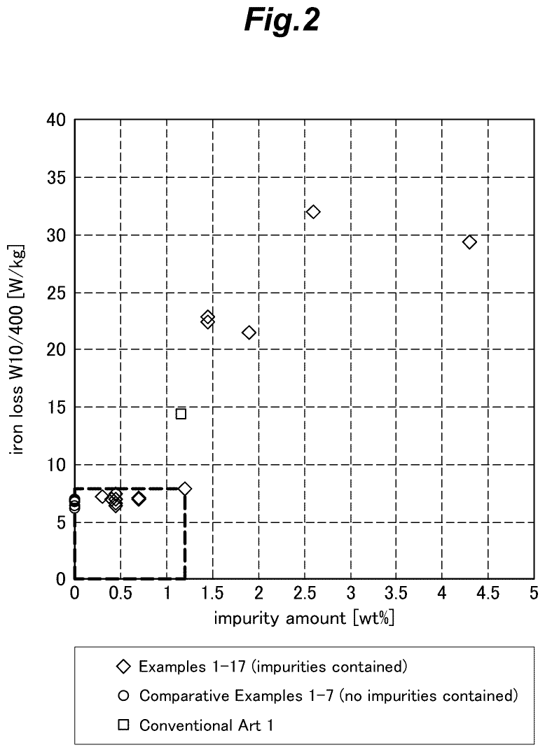

Next, the evaluation results of the magnetic properties of the soft magnetic steel sheets of Examples 1 to 40 and Comparative Examples 1 to 25 will be described in the following with reference to Tables 1 to 4 and FIGS. 2 to 10. The graphs in FIGS. 2 to 5 and 7 to 10 are based on the data shown in Tables 1 to 4.

FIG. 2 shows the relationship between the amount of impurities [wt %] and the iron loss W10/400 [W/kg] for Examples 1 to 17, Comparative Examples 1 to 7, and Conventional Art 1. Here, the iron loss W10/400 of the soft magnetic steel sheet is preferably 8 W/kg or less to reduce energy consumption. The thick frame in FIG. 2 indicates a region where the iron loss W10/400 is 8 W/kg or less and the amount of impurities [wt %] is 1.2 wt % or less.

As shown in FIG. 2 (also see Tables 1 to 4), in Examples 1 to 12where the sum of Cu, Cr, Ni, and Sn contents is 1.2 wt % or less (see the plots within the thick frames in FIG. 2), the iron loss W10/400 is 8 W/kg or less. Similarly, in Comparative Examples 1 to 7 where the contents of Cu, Cr, Ni, and Sn are zero, the iron loss W10/400 is 8 W/kg or less.

On the other hand, in Examples 13 to 17 where the sum of Cu, Cr, Ni, and Sn contents exceeds 1.2 wt % (see the plots outside the thick frame in FIG. 2), the iron loss W10/400 exceeds 8 W/kg.

Further, in the Conventional Art 1 using hot rolling, although the sum of Cu, Cr, Ni, and Sn contents is 1.2 wt % or less, the iron loss W10/400 greatly exceeds 8 W/kg.

According to FIG. 2, when the soft magnetic steel sheet contains 0.10 to 1.0 wt % of Cu, 0.01 to 0.5 wt % of Cr, 0.01 to 0.5 wt % of Ni, and 0.01 to 0.3 wt % of Sn as impurities, and the sum of Cu, Cr, Ni, and Sn contents is 1.2 wt % or less, the iron loss W10/400 of the soft magnetic steel sheet can be kept at a favorable value (8 W/kg or less).

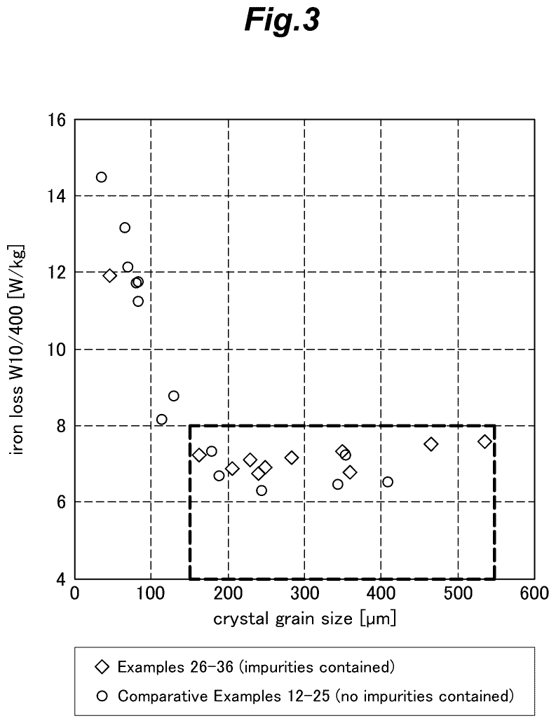

FIG. 3 shows the relationship between the crystal grain size (average value) [μm] and the iron loss W10/400 [W/kg] for Examples 26 to 36 and Comparative Examples 12 to 25. The thick frame in FIG. 3 indicates a region where the iron loss W10/400 is 8 W/kg or less and the crystal grain size is 150 to 550 μm.

As shown in FIG. 3 (also see Tables 1 to 4), in Examples 26 to 33and 35 to 36 where the crystal grain size is in the range of 150 to 550 μm (see the plots within the thick frame in FIG. 3), the iron loss W10/400 is 8 W/kg or less. Similarly, in Comparative Examples 18 and 21 to 25 where the crystal grain size is in the range of 150 to 550 μm, the iron loss W10/400 is 8 W/kg or less.

On the other hand, in Example 34 where the crystal grain size is less than 150 μm (47 μm), the iron loss W10/400 exceeds 8 W/kg. Further, in Comparative Examples 12 to 17 and 19 to 20 where the crystal grain size is less than 150 μm, the iron loss W10/400 exceeds 8 W/kg.

FIG. 3 shows that the crystal grain size needs to be in the range of 150 to 550 μm to keep the iron loss W10/400 of the soft magnetic steel sheet 8 W/kg or less.

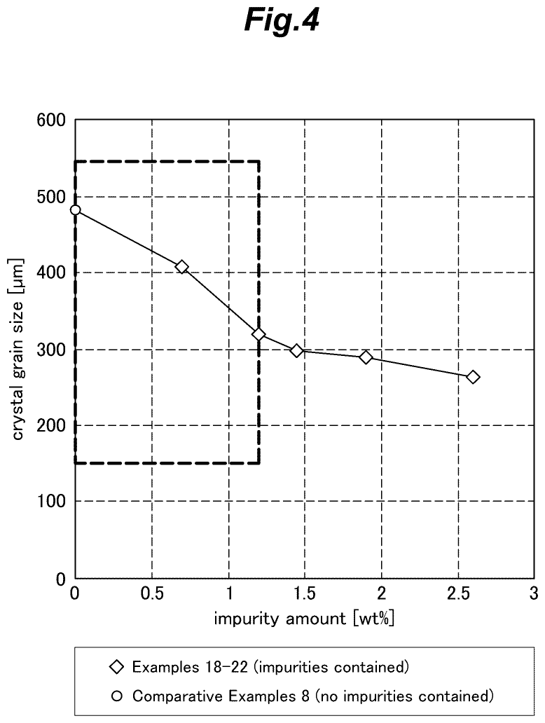

FIG. 4 shows the relationship between the amount of impurities [wt %] and the crystal grain size (average value) [μm] for Examples 18 to 22 and Comparative Example 8. In Examples 18 to 22 and Comparative Example 8, the heat treatment was performed under the same conditions (in an Ar atmosphere at 1150° C. for 24 hours). Further, the thick frame in FIG. 4 indicates a region where the amount of impurities [wt %] is 1.2 wt % or less and the crystal grain size is 150 to 550 μm.

According to FIG. 4, when the amount of impurities [wt %] of the soft magnetic steel sheet is 1.2 wt % or less, the crystal grain size is in the range of 150 to 550 μm.

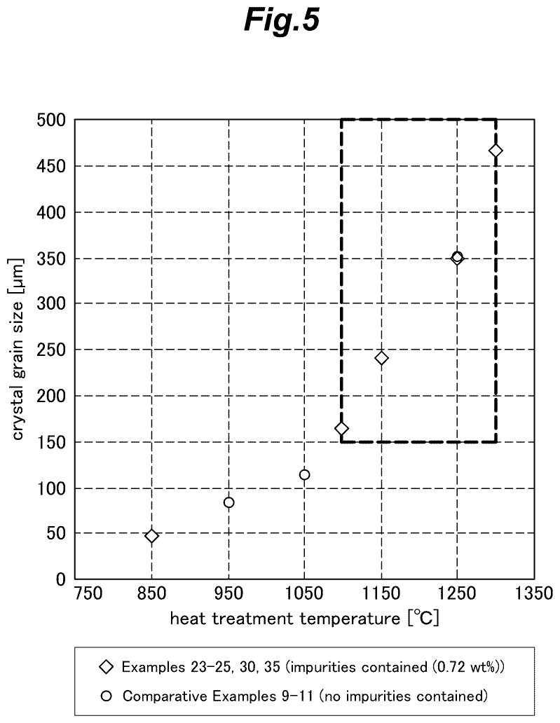

FIG. 5 shows the relationship between the heat treatment temperature [° C.] and the crystal grain size (average value) [μm] for Examples 23 to 25, 30, and 35 and Comparative Examples 9 to 11. The thick frame in FIG. 5 indicates a region where the crystal grain size is 150 to 500 μm (that is, 550 μm or less) and the heat treatment temperature is 1,100 to 1,300° C.

According to FIG. 5, when the heat treatment temperature of the soft magnetic steel sheet is in the range of 1,100 to 1,300° C., the crystal grain size is in the range of 150 to 500 μm (i.e., 550 μm or less).

As shown in Tables 1 and 2, in other Examples not shown in FIGS. 4 and 5, when the amount of impurities [wt %] is 1.2 wt % or less and the heat treatment temperature is in the range of 1,100 to 1,300° C., the crystal grain size is in the range of 150 to 550 μm or less.

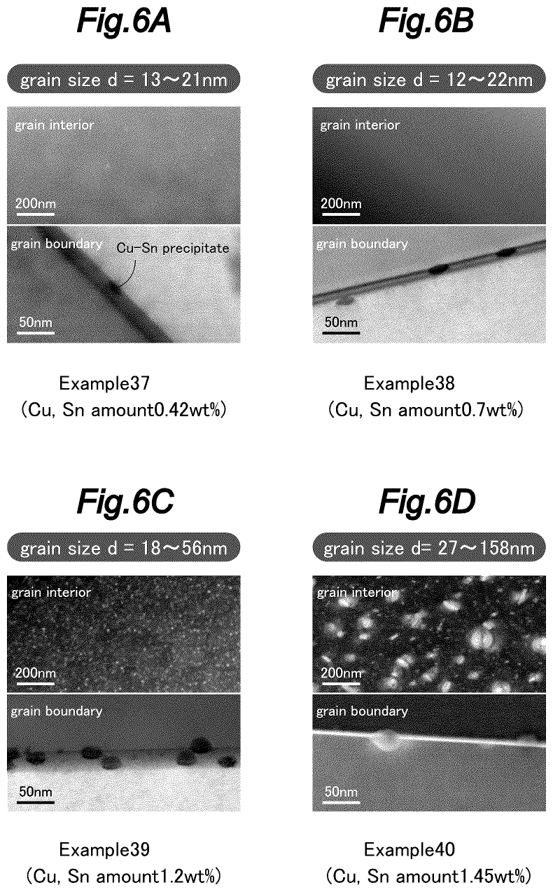

FIGS. 6A to 6D show transmission electron microscope (TEM) images of (A) Example 37, (B) Example 38, (C) Example 39, and (D) Example 40. The TEM images for each Example include images of the grain interior and the crystal grain boundaries. The value of the grain size d of the Cu—Sn precipitate shown in FIGS. 6A to 6D was calculated by the method described above.

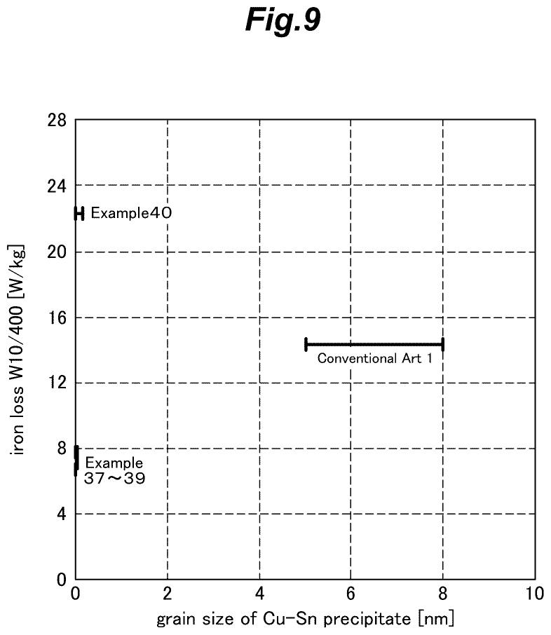

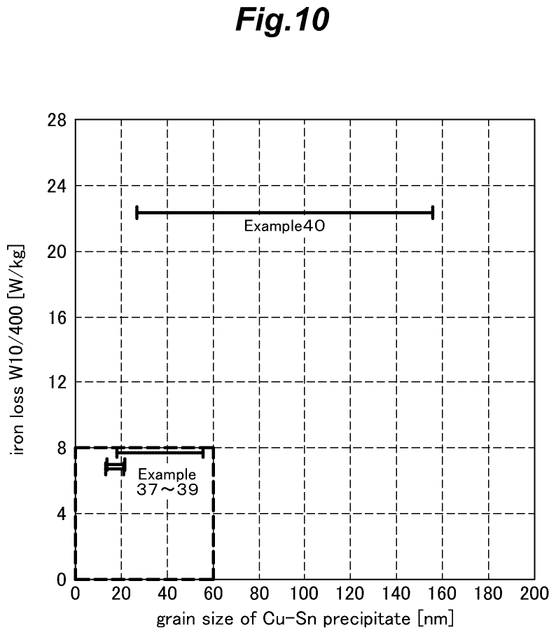

FIGS. 6A to 6D show that, as the amount of Cu and Sn (i.e., the Cu and Sn contents) increases, the grain size d of the Cu—Sn precipitate increases. As will be described later with reference to FIGS. 9 and 10, the grain size d of the Cu—Sn precipitate needs to be about 60 nm or less (here, 56 nm or less) to keep the iron loss W10/400 of the soft magnetic steel sheet 8 W/kg or less (corresponding to Examples 37 to 39).

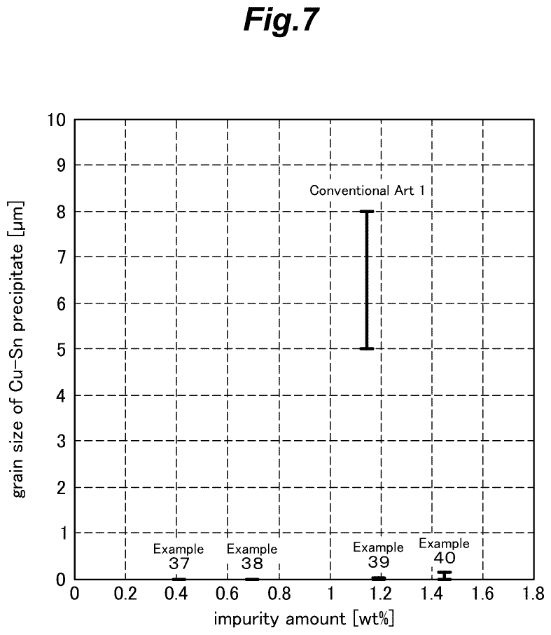

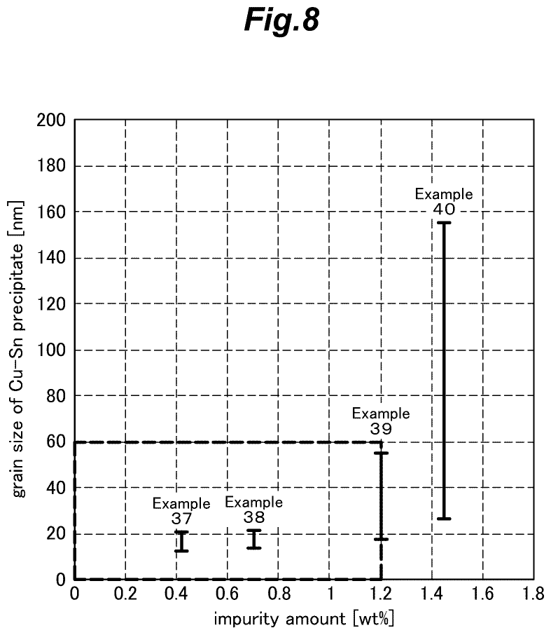

FIG. 7 shows the relationship between the amount of impurities [wt %] and the grain size [μm] of the Cu—Sn precipitate for Examples 37 to 40 and Conventional Art 1. FIG. 8 focuses on Examples 37 to 40 by changing the scale of the vertical axis shown in FIG. 7.

FIGS. 7 and 8 show that when the amount of impurities (i.e., the sum of the content of impurities) is 1.2 wt % or less (corresponding to Examples 37 to 39), the grain size of the Cu—Sn precipitate is 60 nm or less.

FIG. 9 shows the relationship between the grain size [μm] of the Cu—Sn precipitate and the iron loss W10/400 [W/kg] for Examples 37 to 40 and Conventional Art 1. FIG. 10 focuses on Examples 37 to 40 by changing the scale of the vertical axis shown in FIG. 9.

FIGS. 9 and 10 show that the grain size of the Cu—Sn precipitate needs to be 60 nm or less to keep the iron loss W10/400 of the soft magnetic steel sheet 8 W/kg or less (corresponding to Examples 37 to 39).

As described in the foregoing, according to the soft magnetic steel sheet and the manufacturing method thereof of the present invention, by appropriately determining the content of components derived from the iron scrap and the crystal grain size (average value), it is possible to suppress deterioration of the magnetic properties and the like, even if impurities derived from the iron scrap are contained in the raw materials.

Furthermore, by making the grain size of the Cu—Sn precipitates 60 nm or less, it is possible to more reliably suppress deterioration of the magnetic properties and the like of the soft magnetic steel sheet. The range of the crystal grain size of the soft magnetic steel sheet can be controlled by appropriately setting the conditions (temperature and time) of the heat treatment.

Concrete embodiments of the present invention have been described in the foregoing, but the present invention should not be limited by the foregoing embodiments and various modifications and alterations are possible within the scope of the present invention.

1. A soft magnetic steel sheet manufactured from a raw material containing iron scrap, the soft magnetic steel sheet including:
Fe as a base material;
1.0 to 7.0 wt % of Si; and
components derived from the iron scrap,
wherein the components derived from the iron scrap include 0.10 to 1.0 wt % of Cu, 0.01 to 0.5 wt % of Cr, 0.01 to 0.5 wt % of Ni, and 0.01 to 0.3 wt % of Sn, and a sum of Cu, Cr, Ni, and Sn is in a range of 0.1 to 1.2 wt %, and
an average crystal grain size is within the range of 150 to 550 μm.

2. The soft magnetic steel sheet according to claim 1, wherein a grain size of Cu—Sn precipitate is 60 nm or less.

3. The soft magnetic steel sheet according to claim 1, wherein the soft magnetic steel sheet has a thickness of 0.03 to 0.15 mm and iron loss W10/400 of 8 W/kg or less.

4. A method for manufacturing the soft magnetic steel sheet according to claim 1, comprising steps of:
forming a belt-shaped thin sheet from the raw material by a solidification method to rapidly cool a liquid on a single roll; and
heat treating the belt-shaped thin sheet in an inert atmosphere at 1,100 to 1,300° C. for 10 minutes to 48 hours.

5. The method for manufacturing the soft magnetic steel sheet according to claim 4, wherein a temperature of the heat treating step is 1,150 to 1,250° C.

6. The method for manufacturing the soft magnetic steel sheet according to claim 5, wherein a time period of the heat treating step is 2 to 24 hours.
